(19) United States
(12) Patent Application Publication
(10) Pub. No.: US 2025/0117771 A1
(43) Pub. Date: Apr. 10, 2025

(54) SYSTEMS AND METHODS FOR EXECUTING SMART PAYMENTS

(71) Applicant: JPMORGAN CHASE BANK, N.A., New York, NY (US)

(72) Inventors: Vinod SINGH, McKinney, TX (US); Lakshmi POLAVARAPU, Frisco, TX (US)

(21) Appl. No.: 18/484,127

(22) Filed: Oct. 10, 2023

(51) Int. Cl. G06Q 20/22; G06Q 40/03

(52) U.S. Cl. CPC G06Q 20/29; G06Q 40/03

(57) ABSTRACT

Systems and methods for executing smart payments are disclosed. According to an embodiment, a method for executing smart payments may include: (1) receiving, by a computer program and from a borrower, a bulk payment for a plurality of loans; (2) retrieving, by the computer program, information on each of the loans, wherein the information comprises a payment amount due for the loan; (3) determining, by the computer program and using a machine learning model that is trained with prior payments to the loans by the borrower, a payment allocation of the bulk payment for each of the loans; and (4) providing, by the computer program, the payment allocation to a loan system for each of the loans, wherein the loan system for each of the loans executes a payment to the loan for the payment allocation.

### BACKGROUND OF THE INVENTION

### 1. Field of the Invention

Embodiments relate to systems and methods for executing smart payments.

### 2. Description of the Related Art

Borrowers often have several loans with a lender, such as a financial institution. So, when the borrower makes a payment, unless the borrower provides express instructions, the lender must determine how the funds are to be applied. This can lead to funds being misapplied.

### SUMMARY OF THE INVENTION

Systems and methods for executing smart payments are disclosed. According to an embodiment, a method for executing smart payments may include: (1) receiving, by a computer program and from a borrower, a bulk payment for a plurality of loans; (2) retrieving, by the computer program, information on each of the loans, wherein the information may include a payment amount due for the loan; (3) determining, by the computer program and using a machine learning model that is trained with prior payments to the loans by the borrower, a payment allocation of the bulk payment for each of the loans; and (4) providing, by the computer program, the payment allocation to a loan system for each of the loans, wherein the loan system for each of the loans executes a payment to the loan for the payment allocation.

In one embodiment, the plurality of loans are with a plurality of lenders.

In one embodiment, the machine learning model may be further trained with messages from the borrower.

In one embodiment, the information further may include a loan type.

In one embodiment, the method may also include: determining, by the computer program, that manual review of the payment allocation is required; receiving, by the computer program, manual allocations of the bulk payment for each of the loans; and assigning, by the computer program, the manual allocations as the payment allocations. The method may also include training, by the computer program, the machine learning model with the manual allocations.

According to another embodiment, a system may include: a borrower electronic device associated with a borrower; a borrower information database comprising information on each of a plurality of loans for the borrower comprising a payment amount due for each of the plurality of loans; a machine learning model that is trained with prior payments by the borrower; a loan system; and an electronic device executing a computer program that may be configured to receive a bulk payment for a plurality of loans from the borrower electronic device, retrieve the information on each of the loans from the borrower information database, determine, using the machine learning model, a payment allocation of the bulk payment for each of the loans, and provide the payment allocation to the loan system for each of the loans, wherein the loan system for each of the loans may be configured to execute a payment to the loan for the payment allocation.

In one embodiment, the plurality of loans are with a plurality of lenders.

In one embodiment, the machine learning model may be further trained with messages from the borrower.

In one embodiment, the information further may include a loan type.

In one embodiment, the computer program may be further configured to determine that manual review of the payment allocation is required, receive manual allocations of the bulk payment for each of the loans, and assign the manual allocations as the payment allocations. The computer program may be further configured to train the machine learning model with the manual allocations.

A non-transitory computer readable storage medium, may include instructions stored thereon, which when read and executed by one or more computer processors, cause the one or more computer processors to perform steps comprising: receiving, from a borrower, a bulk payment for a plurality of loans; retrieving information on each of the loans, wherein the information may include a payment amount due for the loan; determining, using a machine learning model that is trained with prior payments by the borrower, a payment allocation of the bulk payment for each of the loans; and providing the payment allocation to a loan system for each of the loans, wherein the loan system for each of the loans executes a payment to the loan for the payment allocation.

In one embodiment, the plurality of loans are with a plurality of lenders.

In one embodiment, the machine learning model may be further trained with messages from the borrower.

In one embodiment, the information further may include a loan type.

In one embodiment, the non-transitory computer readable storage medium may also include instructions stored thereon, which when read and executed by one or more computer processors, cause the one or more computer processors to perform steps comprising: determining that manual review of the payment allocation is required; receiving manual allocations of the bulk payment for each of the loans; and assigning the manual allocations as the payment allocations. The non-transitory computer readable storage medium may also include instructions stored thereon, which when read and executed by one or more computer processors, cause the one or more computer processors to train the machine learning model with the manual allocations.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for executing smart payments according to an embodiment;

FIG. 2 illustrates a method for executing smart payments according to an embodiment; and

FIG. 3 depicts an exemplary computing system for implementing aspects of the present disclosure.

### DETAILED DESCRIPTION OF PREFERRED EMBODIMENTS

Embodiments relate to systems and methods for executing smart payments.

When a bulk payment from a borrower with multiple loans is received, embodiments may intelligently calculate the payment due for each loan or transaction type and make the payments from the bulk payment. For example, embodiments may use a trained machine learning engine to identify the appropriate payments. If the payments need review, embodiments may notify an operations team for review and approval. Embodiments may create reports following payment.

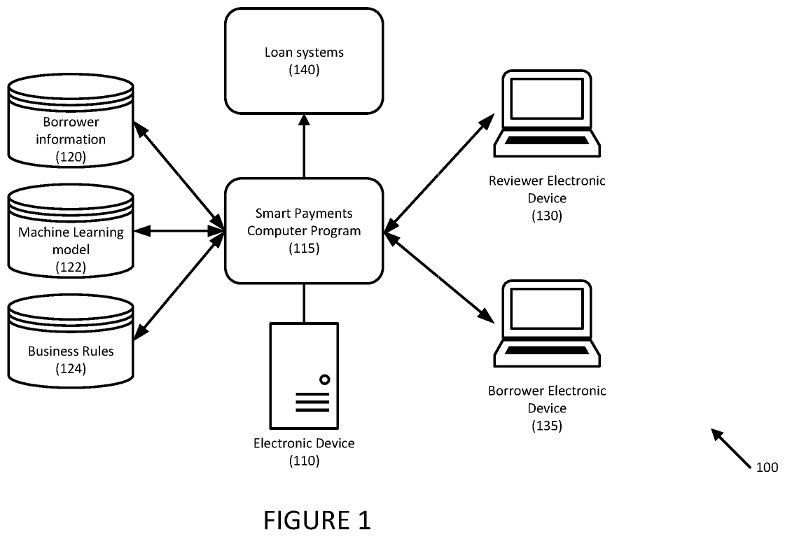

Referring to FIG. 1, a system for executing smart payments is disclosed according to an embodiment. System 100 may include electronic device 110 that may execute smart payments computer program 115. Electronic device 110 may include any suitable electronic device, including servers (e.g., physical and/or cloud-based), computers (e.g., workstations, desktops, laptops, tablets, etc.), smart devices (e.g., smart phones, smart watches, etc.), Internet of Things (IoT) appliances, etc.

In one embodiment, electronic device 110 may be provided or hosted by a financial institution from which a borrower may have loans. In another embodiment, electronic device 110 may be provided or hosted by a financial technology (FinTech) services entity, an aggregator, etc. that may provide services for a plurality of financial institutions with which the borrower may have loans, lines of credit (e.g., credit cards), etc.

The loans may include business loans, personal loans, lines of credit (e.g., credit cards), mortgages, etc.

Smart payments computer program 115 may receive a bulk payment from a borrower that may have a plurality of loans and/or transactions, and may retrieve information on the borrower's loans and/or transactions, such as any amounts due, from borrower information database 120. It may apply machine learning model 122 to determine the allocation of the bulk payment to the borrower's loans and/or transactions.

In one embodiment, if smart payments computer program 115 is provided by an aggregator, smart payments computer program 115 may interface with borrower information 120 from a plurality of financial institutions with which the borrower has loans.

Smart payments computer program 115 may also apply any business rules 124 provided by the financial institution(s). For example, business rules 124 may specify an order of payment, how overpayments are allocated, etc.

Once the allocation is determined, smart payments computer program 115 may provide the payment allocations to loan systems 140, which may execute the payments. Each financial institution may have its own loan system 140.

If an exception or conflict is identified, smart payments computer program 115 may generate a notification and send it to reviewer electronic device 130. A reviewer may provide input on payment to reviewer electronic device 130, which may be returned to smart payments computer program 115 for execution.

Any feedback received from the reviewer, or the borrower via, for example, borrower electronic device 135, may be used to update machine learning model 122.

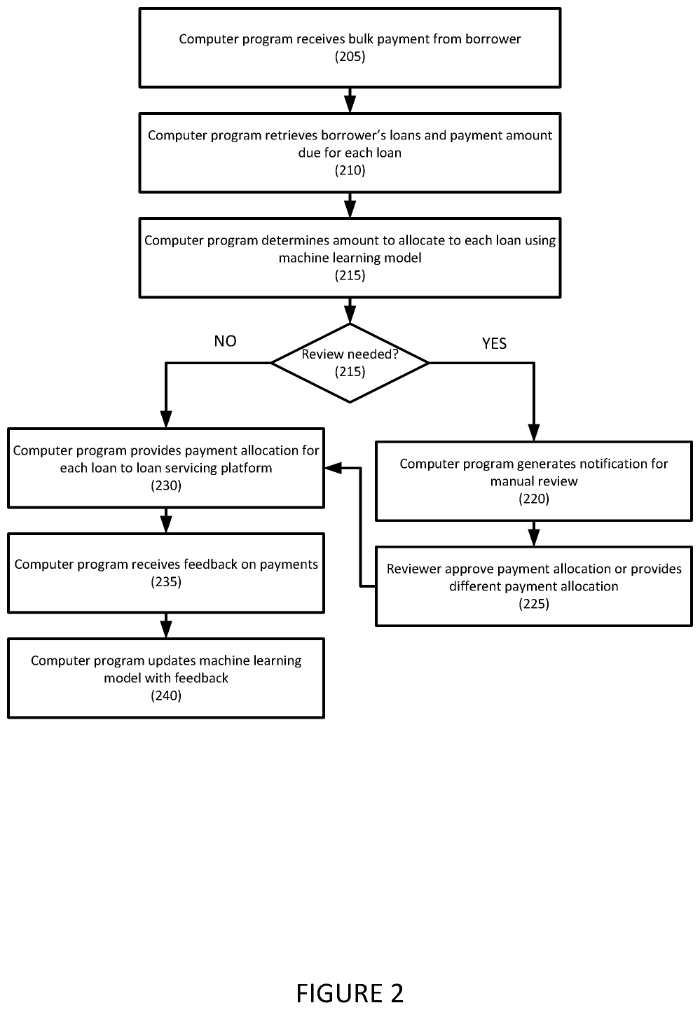

Referring to FIG. 2, a method for executing smart payments is disclosed according to an embodiment.

In step 205, a computer program, such as a smart payments computer program, executed on an electronic device may receive a bulk payment from a borrower. The bulk payment may be for a plurality of loans and/or transactions that the borrower may have with one or more lenders.

In step 210, the computer program may retrieve information on the borrowers loans and/or transactions, such as the type of loans/transactions and the payment amount due for each loan/transaction.

In one embodiment, the computer program may retrieve information from a plurality of lenders.

in step 215, the computer program may determine the amount to allocate to each loan/transaction using a machine learning model. The machine learning model may be trained with prior payments to the loans by the borrower, messages (e.g., emails, texts, phone communications, etc.) from the borrower, reports, manual data, etc. The machine learning model may return the loans and/or transactions types with payment amounts for each loan/transaction.

In step 220, the computer program may determine whether manual review is needed to identify the payment amounts. If it is, in step 225, the computer program may generate a notification for a reviewer to manual review or provide the payment allocations.

In step 230, the reviewer may return approval of the allocation or may provide a manual allocation. The computer program may then assign the approved or manual allocations to the payment allocations.

If manual review is not needed, or the reviewer's input has been received, in step 230, the computer program may provide the payment allocation to one or more loan servicing platforms, which may execute the payment. In one embodiment, if the payments are being made to a plurality of lenders, the computer program may provide the allocations to a plurality of payment systems.

In step 235, the computer program may receive feedback on the payment allocations, and in step 240, may update the machine learning model with the feedback.

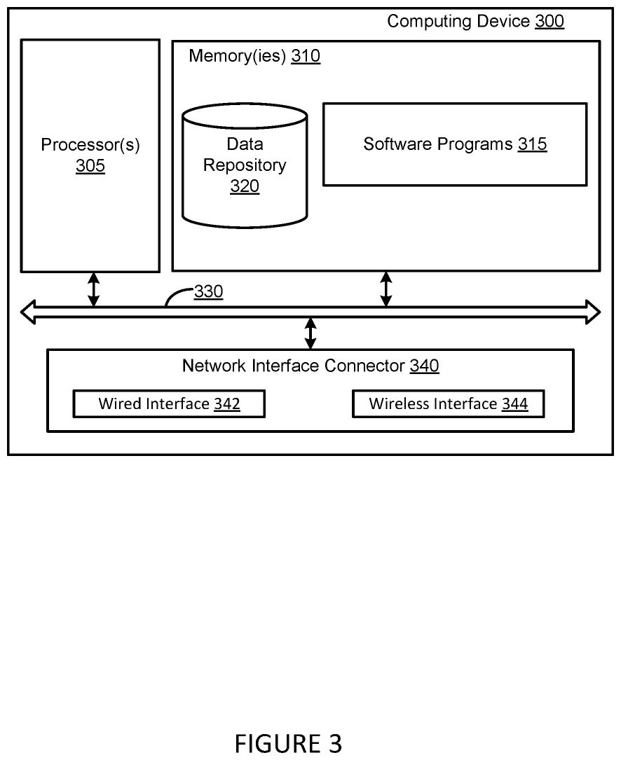

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for executing smart payments, comprising:
receiving, by a computer program and from a borrower, a bulk payment for a plurality of loans;
retrieving, by the computer program, information on each of the loans, wherein the information comprises a payment amount due for the loan;
determining, by the computer program and using a machine learning model that is trained with prior payments to the loans by the borrower, a payment allocation of the bulk payment for each of the loans; and
providing, by the computer program, the payment allocation to a loan system for each of the loans, wherein the loan system for each of the loans executes a payment to the loan for the payment allocation.

2. The method of claim 1, wherein the plurality of loans are with a plurality of lenders.

3. The method of claim 1, wherein the machine learning model is further trained with messages from the borrower.

4. The method of claim 1, wherein the information further comprises a loan type.

5. The method of claim 1, further comprising:
determining, by the computer program, that manual review of the payment allocation is required;
receiving, by the computer program, manual allocations of the bulk payment for each of the loans; and
assigning, by the computer program, the manual allocations as the payment allocations.

6. The method of claim 5, further comprising:
training, by the computer program, the machine learning model with the manual allocations.

7. A system, comprising:
a borrower electronic device associated with a borrower;
a borrower information database comprising information on each of a plurality of loans for the borrower comprising a payment amount due for each of the plurality of loans;
a machine learning model that is trained with prior payments by the borrower;
a loan system; and
an electronic device executing a computer program that is configured to receive a bulk payment for a plurality of loans from the borrower electronic device, retrieve the information on each of the loans from the borrower information database, determine, using the machine learning model, a payment allocation of the bulk payment for each of the loans, and provide the payment allocation to the loan system for each of the loans, wherein the loan system for each of the loans is configured to execute a payment to the loan for the payment allocation.

8. The system of claim 7, wherein the plurality of loans are with a plurality of lenders.

9. The system of claim 7, wherein the machine learning model is further trained with messages from the borrower.

10. The system of claim 7, wherein the information further comprises a loan type.

11. The system of claim 7, wherein the computer program is further configured to determine that manual review of the payment allocation is required, receive manual allocations of the bulk payment for each of the loans, and assign the manual allocations as the payment allocations.

12. The system of claim 11, wherein computer program is further configured to train the machine learning model with the manual allocations.

13. A non-transitory computer readable storage medium, including instructions stored thereon, which when read and executed by one or more computer processors, cause the one or more computer processors to perform steps comprising:
receiving, from a borrower, a bulk payment for a plurality of loans;
retrieving information on each of the loans, wherein the information comprises a payment amount due for the loan;
determining, using a machine learning model that is trained with prior payments by the borrower, a payment allocation of the bulk payment for each of the loans; and
providing the payment allocation to a loan system for each of the loans, wherein the loan system for each of the loans executes a payment to the loan for the payment allocation.

14. The non-transitory computer readable storage medium of claim 13, wherein the plurality of loans are with a plurality of lenders.

15. The non-transitory computer readable storage medium of claim 13, wherein the machine learning model is further trained with messages from the borrower.

16. The non-transitory computer readable storage medium of claim 13, wherein the information further comprises a loan type.

17. The non-transitory computer readable storage medium of claim 13, further including instructions stored thereon, which when read and executed by one or more computer processors, cause the one or more computer processors to perform steps comprising:
determining that manual review of the payment allocation is required;
receiving manual allocations of the bulk payment for each of the loans; and
assigning the manual allocations as the payment allocations.

18. The non-transitory computer readable storage medium of claim 17, further including instructions stored thereon, which when read and executed by one or more computer processors, cause the one or more computer processors to train the machine learning model with the manual allocations.
